(19) United States
(12) Patent Application Publication
(10) Pub. No.: US 2011/0142221 A1
(43) Pub. Date: Jun. 16, 2011

(54) SYSTEM AND METHOD FOR AUTOMATED GROUP CALLING SERVICE BASED ON KEY WORDS

(75) Inventors: Mostafa TOFIGHBAKHSH, Cupertino, CA (US); Milap Majmundar, Austin, TX (US)

(73) Assignee: AT&T Intellectual Property I, L.P., Reno, NV (US)

(21) Appl. No.: 12/638,598

(22) Filed: Dec. 15, 2009

(51) Int. Cl. H04M 3/42

(52) U.S. Cl. 379/202.01; 379/207.13

(57) ABSTRACT

Disclosed herein are systems, methods, and computer-readable storage media for establishing conference calls. A system practicing the method receives a key word from a speaker on a call, retrieves a list of entities associated with the key word, and sends invitations to the entities to join the call. In one variation, the system further receives from an invited entity a request to join the call, and adds the invited entity to the call. In another variation, the system further records a portion of the call, and transmits the recorded portion of the call to invited entities which are not added to the call. The key word can be a word or phrase, and can be a spoken word and/or alphanumeric text. The system can dynamically generate the list of entities based on the key word. The invitation can be sent via an automated call, email, and/or an SMS message.

### BACKGROUND

1. Technical Field

The present disclosure relates to conference calls and more specifically to automatically joining a group of individuals on a group call based on key words.

2. Introduction

Conference calls are a common part of business in the modern world. Even in the face of e-mail and other more recent communication means, conference calls remain important. However, conference calls can be difficult to coordinate and set up, and are not very flexible once established. Multiple lists of conference participants can be difficult to manage. Some interfaces for performing these tasks are complicated and non-intuitive. Despite all these hindrances, conference calls continue as a business mainstay. However, conference calling could be even more commonly used if these deficiencies were remedied.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example method embodiment; and

FIG. 3 illustrates an example system configuration for an automated group calling service.

### DETAILED DESCRIPTION

This disclosure describes a group calling system, method, computer-readable medium, and service that enables telecommunications customers to dynamically engage a pre-defined group of people in a phone conversation. When one or more callers are actively engaged in a conversation on a call, depending upon the topic of conversation, one of the callers can decide to engage a group of people related to the topic of conversation based on a pre-defined keyword and a pre-defined and/or dynamically generated group of people associated with that keyword. The keyword can be triggered via a * code entered on a mobile device keypad, for example, and voice recognition of the pre-defined keyword spoken by one of the callers. In one variation, only the caller who initiated the group call can conference others in. The keyword can trigger the network to automatically call or otherwise notify members of the pre-defined group of people associated with the recognized keyword. When the members of the group receive the notification, they can immediately join the conversation by accepting the call, or join the conversation by calling in to a provided call-back number. Even if invited individuals are unable to join, members of the group will have an indication that they missed a call from the group defined by the keyword, thus allowing them to follow-up appropriately. In some situations, the conference call initiator can instruct the system to record the call and make it available to all participants, all invited parties, and/or anyone else. The following use cases illustrate the concepts disclosed herein.

The first use case is an enterprise scenario. John is a Director of Technology Development in a high tech company. He regularly engages in conversations with different technical teams in the company related to different technical topics. One day John is engaged in a phone conversation with his boss, Mary. Mary asks John about the status of a project called NewCoolWidget and also about some specific issues that the project is dealing with. Mary needs to provide the status of this project to a company executive with whom she has a meeting scheduled later that day. Because a technical team (i.e. not John personally) leads the NewCoolWidget project, John is not aware of specific details of the project status. Luckily John has a pre-defined group calling keyword named NewCoolWidget, including the desk phone number for project manager and cell phone numbers for two subordinates in the group list.

When asked about the project status, John places Mary on hold momentarily. Then John presses the * code related to the special group calling feature (such as *07 or other * code) and says the keyword “NewCoolWidget”. The network identifies the spoken key word as an automated group call request and performs automatic speech recognition (ASR) on the keyword from John. The network then triggers phone calls to the NewCoolWidget project manager and his two subordinates. Unfortunately the project manager for the NewCoolWidget project is busy in a meeting so the call to his desk phone goes to his voice mail. The network leaves a voice message with a call-back number in case the project manager is able to join the call in the next few minutes.

When subordinate 1 receives the group phone call on his cell phone, subordinate 1 has gone to the copier machine leaving his cell phone near his computer, so he misses the call, too. The network leaves a voice message (just as in the case of the project manager), but also sends an SMS to subordinate 1's cell phone providing a call-back number to join the conversation within the next few minutes. The network can inform the group members to join the group by voice mail, email, SMS, or other ways. The methodology for “group call joining” may be indexed based on pre-set orders and or learned by the network based on real time or logs of user behavior.

When subordinate 2 receives the group phone call on her cell phone, she picks up the call and is immediately connected to the phone conversation between John and Mary. John asks subordinate 2 about the overall status of the project, which she is able to provide. However, she is unable to provide specific details of one issue that subordinate 1 is dealing with. Meanwhile, subordinate 1 returns to his desk from the copier machine. He sees the SMS and calls in to join the conference call. John asks subordinate 1 about the issue and gets answers to Mary's questions. Due to this, Mary (the boss) is able to provide a very accurate status of the NewCoolWidget project in her presentation to the company executive at the meeting later that day.

In this use case, the group calling feature significantly decreased the amount of time required to obtain information from a dispersed team, thereby improving the efficiency of the organization.

The second use case is a social consumer scenario. Martha recently found an old high school friend, Beth, on Facebook. They exchanged phone numbers and now they are talking on the phone about all the good times they had together in high school. Beth asks Martha if she's in touch with any of the other four friends that were close to them in school. Martha says that she's in touch with all of them and asks Beth if she would like to talk to them. Beth is thrilled with the idea so Martha asks her to hold on for a minute and presses the * code related to the special group calling feature and utters the key phrase “High School Gang”, which she had set up some time ago.

The network dials all members of the “High School Gang” group, some of whom pick up the phone right away and are able to talk to Beth after many years of being out of touch with her. Some members, who are unable to answer the phone call, call in a few minutes later based on the call-back number they received in their voice mail or SMS message. Some members are unable to call back before the call ends. However, because they have the voice mail and SMS message with the keyword “High School Gang” in it, they know that this was a call from their old high school group. Later in the day they exchange messages with Martha to find out that the call was to get in touch with Beth.

Martha goes to a website for managing the special group feature and adds Beth's name and phone number in the “High School Gang” group so that in the future she too is included in any such group calls. Martha can distribute the “High School Gang” group for use by the other members, so each member does not need to manually create their own group. In one aspect, group members can view others' groups which include them and opt out of specific groups, if they desire.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

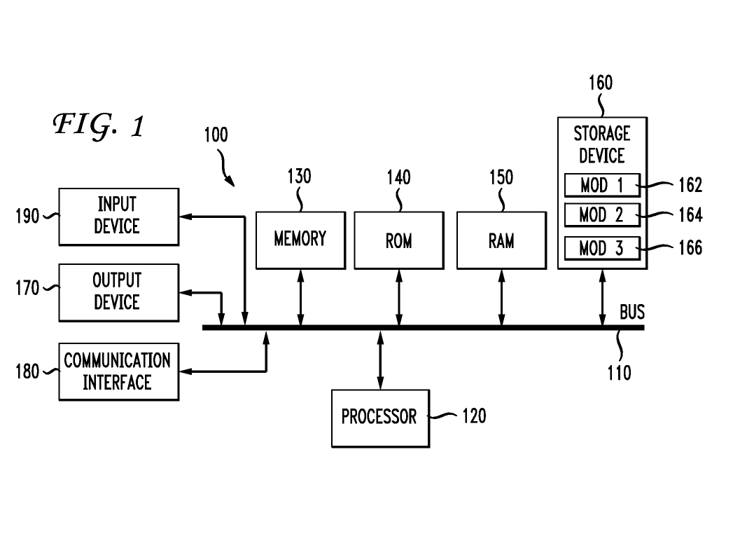

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. These and other modules can be configured to control the processor 120 to perform various actions. Other system memory 130 may be available for use as well. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a tangible and/or intangible computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Tangible computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. The input device 190 may be used by the presenter to indicate the beginning of a speech search query. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage media. Generally speaking, such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

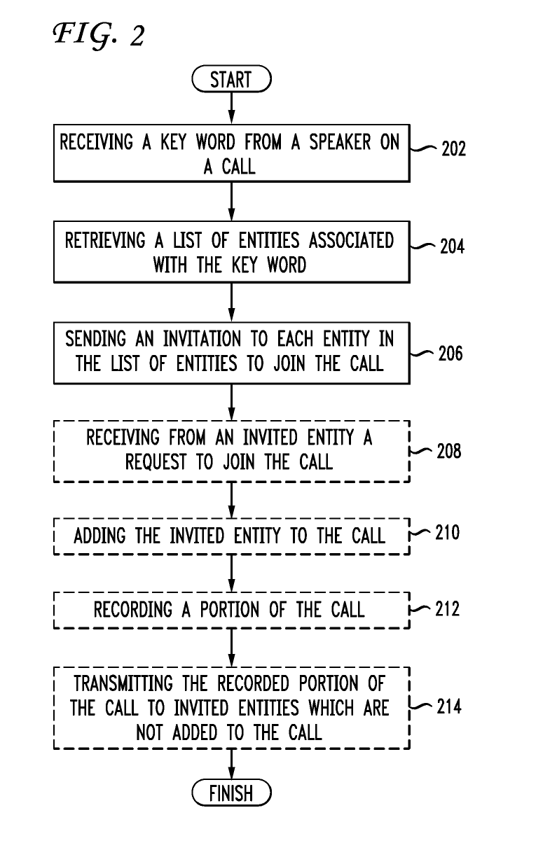

Having disclosed some basic system components, the disclosure now turns to the exemplary method embodiment for establishing a conference call, as shown in FIG. 2. For the sake of clarity, the method is discussed in terms of an exemplary system such as is shown in FIG. 1 configured to practice the method.

The system 100 receives a key word from a speaker on a call (202). The key word can be a spoken word or phrase, or alphanumeric text. In some cases, the spoken word is preceded by a * code (such as *44) to indicate to the system 100 that the following utterance is a key word. In other cases, the system 100 can recognize a spoken equivalent to a * code before the key word or phrase, such as a user saying “group call, ‘High School Gang’.”

The system 100 retrieves a list of entities associated with the key word (204). The list of entities can be predetermined by the speaker, or by another entity, such as a company, church, or neighborhood directory. In one aspect, the system dynamically generates list of entities based on the key word or phrase. For example, if the key phrase is “marketing department”, the system 100 can look up a company directory and join all people in the company directory with marketing in their title or department description. Retrieving the list of entities can further be based on a calling device of the speaker. For example, the list of entities can be generated from contacts or contact groups listed in a local list of contacts on a calling device such as a smart phone or caller ID unit of a land line telephone.

The system can also retrieve the list of entities based on the speaker's location. If a nationwide sales manager has a large distribution list of all employees across the country, the manager can further limit the keyword by saying, for example, “all employees, within 50 miles” and the system will restrict the large distribution list to employees whose actual location (which can be determined via GPS) or associated address (such as workplace or home address) is within 50 miles of the current location of the sales manager. These and other dynamic variations of generating distribution lists from key words exist.

Further, as an added value service, the system 100 can identify a list of likely entities associated with the key word which are not part of the retrieved list of entities. For example, if a list includes 5 of the 7 board members of a company, or 6 of 7 immediate family members, the system can identify the missing entities which the user is likely to have intended to include. The key word and the content of the call itself can provide clues to the system 100 when determining likely entities. The system 100 can then suggest to the speaker via speech or a display or a multimodal interface to add one or more of the list of likely entities to the call.

In one variation, the system receives a list of excluded entities from the speaker and excludes them when sending the invitations. The speaker can enter the list of excluded entities orally or by interacting with a mobile device. For example, the speaker can say “my family, except Lynn” if the conference call is to discuss a surprise birthday party for Lynn. In another example, the speaker says “accounting department” and the speaker's smartphone displays the current list of entities associated with that key word. The speaker can select or deselect certain of the displayed list on the smartphone before approving transmission of the invitations to those people. At the end of such an interaction, the system 100 can ask the speaker if he or she wishes to save the edited list of entities associated with that key word.

The system 100 sends an invitation to each entity in the list of entities to join the call (206). The invitation can be at least one of an automated invitation call, an email, and a short messaging service (SMS) message. When the invitation is a call, the system can immediately conference in the invited party when they answer the call. In another variation, the system asks the invited party to press 1, for example, to join the conference or press 2 to indicate that they are unavailable to join the conference. The invitation call can include the key word or phrase as recorded speech (such as the recorded speech of the conference call initiator), automated speech, and/or as text (such as in a Caller ID field). If the invitation is not a call, the invitation can include a dial-in number and/or an authentication code. If the invitation is an email, the email can include a link to join the conference via Voice over IP.

In one aspect, the system further receives from an invited entity a request to join the call (208) and adds the invited entity to the call (210). Invited entities can join with as many media channels as their device supports. For example, if the call is a video conference, then certain participants without video conference ability can join in with audio only. If other participants are at an Internet-enabled computer that has speakers but no microphone, they can join the call and hear what is going on and communicate by typing messages which the system 100 converts to speech on their behalf. In a further optional variation, the system 100 records a portion of the call (212) and transmits or makes available the recorded portion of the call to invited entities which are not added to the call (214).

In one aspect, the system 100 further infers an address for at least one entity of the list of entities based on words spoken in the call. The system can translate spoken words or phrases to text and process the extracted text using intelligent algorithms to determine the address and/or look up relevant resources, files, or projects.

For example, President Obama and Secretary Clinton are discussing a special issue about global warming. In their conversation, they want to bring on the call the top scientist involved in the last 2 months on the global warming project X. They use the normal procedure with the key words “Global warming scientist on the project X”. The key words can be input deliberately or extracted by automatically monitoring the conversation for keywords. The system automatically searches related internal and/or external resources such as project status, white papers, websites, and presentations in the appropriate locations associated with project X. The system can extract addresses and resources autonomously without manual provisioning to the extent possible.

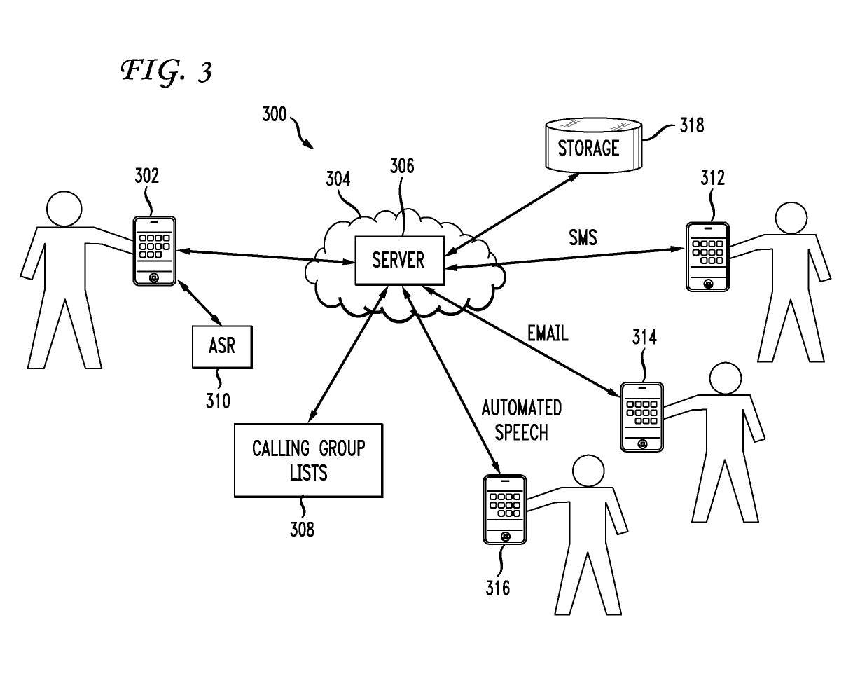

FIG. 3 illustrates an example system configuration 300 for an automated group calling service. A caller 302 with a communications device says or enters a key word or phrase. The communications device transmits the key word or phrase to a server 306 in a network 304. If the key word or phrase is speech, the communications device can include an automatic speech recognition (ASR) module 310 to convert the speech to text. The server 306 or network 304 can also include one or more ASR module (not shown) to convert the speech to text. The server 306 compares the key word or phrase to a set of calling group lists 308 which can be stored in the server 306, in the network 304, and/or external to the network. The server 306 retrieves a calling group list associated with the key word and optionally with the caller 302. The server 306 then sends invitations to individuals on the calling group list. The calling group list can indicate a preferred delivery method for each individual on the list, or the caller 302 can indicate delivery preferences. The server sends an SMS message to a first individual 312, an email message to a second individual 314, and an automated speech message to a third individual 316. These individuals 312, 314, 316 can accept the invitation and join the conference call with the caller 302. The individuals can connect to the caller 302 through the server 306 or through a direct telecommunications connection. Connections through the server 306 allow the server to record the conversation for later retrieval.

Users can set up keywords and groups of people with corresponding calling numbers associated with each group member through a group calling website. Users enter the keywords and group member information and otherwise manage the keywords and groups at such a website. Users can share access with their groups with other group members so that other group members can also initiate conference calls using the group key word, where other groups are private and specific to one user.

When a caller initiates a group call, the system can set up the group call in a number of ways. First, if the caller is already in a phone conversation with another party, they can initiate the group call by calling a * code and speaking the keyword associated with the group that the caller wants to join in the conversation. However, the caller need not be in a phone conversation with another party in order to initiate the group call. The caller could dial a toll-free number related to this group calling feature and, when prompted, speak the keyword associated with the group calling feature.

Upon initiation of the group call, the network calls all the numbers listed in the group associated with the keyword triggered by the caller. When each number on the list is called the system can take the following steps. When the system calls group members, the system transmits the group name (and/or the key word) as part of the Caller ID field of the called party's phone. This will help the called party to realize that this phone call is related to the key word and will help the party decide whether to answer the call. If the called party answers the phone, the system directly connects them in conference with the caller who initiated the group call. As more members of the group call in, the system connects each member to the group conference call.

If the called party does not answer the phone because they are not available or choose not to answer, the system can leave a message with the keyword and a call-back number at the called party's answering machine or voice mail service. If the called party's number is a mobile number, in addition to the above step the network can also send an SMS to the called party's mobile number providing the keyword and the call-back number.

Embodiments within the scope of the present disclosure may also include tangible computer-readable storage media for carrying or having computer-executable instructions or data structures stored thereon. Such computer-readable storage media can be any available media that can be accessed by a general purpose or special purpose computer, including the functional design of any special purpose processor as discussed above. By way of example, and not limitation, such computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, while the principles disclosed herein are primarily discussed in terms of telephone calls, the same principles can be extended to video conferences, interactive web environments, multiplayer games, and other network-based collaborative environments. Those skilled in the art will readily recognize various modifications and changes that may be made to the principles described herein without following the example embodiments and applications illustrated and described herein, and without departing from the spirit and scope of the disclosure.

We claim:

1. A computer-implemented method of establishing conference calls, the method causing a computing device to perform steps comprising:
receiving a key word from a speaker on a call;
retrieving a list of entities associated with the key word; and
sending an invitation to each entity in the list of entities to join the call.

2. The computer-implemented method of claim 1, the method further causing the computing device to perform steps comprising:
receiving from an invited entity a request to join the call; and
adding the invited entity to the call.

3. The computer-implemented method of claim 2, the method further causing the computing device to perform steps comprising:
recording a portion of the call; and
transmitting the recorded portion of the call to invited entities which are not added to the call.

4. The computer-implemented method of claim 1, wherein the key word is a word or phrase.

5. The computer-implemented method of claim 1, wherein the key word is one of a spoken word and alphanumeric text.

6. The computer-implemented method of claim 1, wherein the list of entities is dynamically generated based on the key word.

7. The computer-implemented method of claim 1, wherein the invitation to join the call is at least one of an automated invitation call, an email, and a short messaging service (SMS) message.

8. The computer-implemented method of claim 1, wherein the invitation includes the key word.

9. The computer-implemented method of claim 1, wherein retrieving the list of entities is further based on a calling device of the speaker.

10. The computer-implemented method of claim 1, wherein retrieving the list of entities is further based on a location of the speaker.

11. The computer-implemented method of claim 1, wherein the invitation includes an authentication code.

12. The computer-implemented method of claim 1, the method further causing the computing device to perform steps comprising:
receiving a list of excluded entities from the speaker; and
not sending the invitation to the list of excluded entities.

13. The computer-implemented method of claim 1, the method further causing the computing device to perform steps comprising:
identifying a list of likely entities associated with the key word which are not part of the retrieved list of entities; and
suggesting to the speaker to add one or more of the list of likely entities to the call.

14. The computer-implemented method of claim 13, wherein identifying a list of likely entities is based on the keyword and content of the call.

15. The computer-implemented method of claim 1, the method further comprising inferring an address for at least one entity of the list of entities based on words spoken in the call.

16. A system for establishing conference calls, the system comprising:
a processor;
a module controlling the processor to receive a key word from a speaker on a call;
a module controlling control the processor to retrieve a list of entities associated with the key word; and
a module controlling control the processor to send an invitation to each entity in the list of entities to join the call.

17. The system of claim 16, the system further comprising:
a module controlling control the processor to receive from an invited entity a request to join the call; and
a module controlling control the processor to add the invited entity to the call.

18. The system of claim 17, the system further comprising:
a module controlling control the processor to record a portion of the call; and
a module controlling control the processor to transmit the recorded portion of the call to invited entities which are not added to the call.

19. A computer-readable storage medium storing instructions which, when executed by a computing device, cause the computing device to establish conference calls, the instructions comprising:
receiving a key word from a speaker on a call;
retrieving a list of entities associated with the key word; and
sending an invitation to each entity in the list of entities to join the call.

20. The computer-readable storage medium of claim 19, wherein the invitation includes the key word.
